(19) United States
(12) Patent Application Publication
(10) Pub. No.: US 2006/0099844 A1
(43) Pub. Date: May 11, 2006

(54) Plate locking systems for mated electrical connectors and methods thereof

(75) Inventors: Liam Holmes, County Cork (IE); Martin O'Donnell, County Cork (IE); Allyssa M. Peterman, Fitchburg, MA (US)

Correspondence Address: MAINE & ASMUS, 100 MAIN STREET, P O BOX 3445, NASHUA, NH, 03061-3445, US

(73) Assignee: Anderson Power Products, Sterling, MA (US)

(21) Appl. No.: 11/194,376

(22) Filed: Aug. 1, 2005

Related U.S. Application Data
(63) Continuation-in-part of application No. 10/644,102, filed on Aug. 19, 2003, now Pat. No. 6,923,670.
(60) Provisional application No. 60/404,566, filed on Aug. 19, 2002.

(51) Int. Cl. H01R 13/62

(52) U.S. Cl. 439/368

(57) ABSTRACT

An electrical connection system includes a first electrical connector, a second electrical connector, and a locking plate. The second electrical connector having one of a projecting boss and a boss opening. The locking plate is connected to the first electrical connector and has the other one of the projecting boss and the boss opening. The engagement of the boss with the boss opening locks the second electrical connector to the first electrical connector.

This application is a continuation-in-part application of U.S. patent application Ser. No. 10/644,102 filed Aug. 19, 2003 which claims the benefit of U.S. Provisional Patent Application Ser. No. 60/404,566 filed Aug. 19, 2002, which are both herein incorporated by reference in their entirety.

### FIELD OF THE INVENTION

This invention relates generally to electrical connectors and, more particularly, a plate locking system for mated electrical connectors.

### BACKGROUND OF THE INVENTION

A variety of different types of electrical connectors are used to couple electrical leads together. Unfortunately, one of the problems with existing electrical connectors, such as Euro DIN connectors, is that with vibration the electrical connectors can easily disconnect.

### SUMMARY OF THE INVENTION

An electrical connection system in accordance with embodiments of the present invention includes a first electrical connector with a first housing, the second electrical connector with a second housing and the plate connected to the first housing. The second housing has one of a catch and a fastener along one surface and the plate has the other one of the catch and the fastener. When the first housing is connected to the second housing to couple the first electrical connector to the second electrical connector, the fastener is detachably engaged with the catch to detachably lock the first electrical connector to the second electrical connector.

A method of making an electrical connection system in accordance with embodiments of the present invention includes providing a first electrical connector with a first housing, providing a second electrical connector with a second housing, and connecting a plate to the first housing. The second housing has one of a catch and a fastener along one surface and the plate has the other one of the catch and the fastener. The fastener detachably engages the catch to detachably lock the first electrical connector to the second electrical connector when the first housing is connected to the second housing.

A method for securing electrical connectors in accordance with embodiments of the present invention includes coupling a first electrical connector which is connected to a plate to a second electrical connector. At least one of a fastener and a catch on the second connector is detachably engaged with the other one of the fastener and the catch on the plate to detachably lock the first electrical connector to the second electrical connector.

The present invention provides a complete and integrated locking system for electrical connectors which prevent the electrical connectors from coming apart during use. Additionally, the present invention provides a mechanism which is simple and easy for an operator to use to quickly unlock electrical connectors.

### BRIEF DESCRIPTION OF THE DRAWINGS

FIG. 1 is a perspective view of an electrical connection system in a locked position in accordance with embodiments of the present invention;

FIG. 2 is a cross-sectional view of the electrical connection system in the locked position shown in FIG. 1;

FIG. 3 is a bottom view of electrical connectors for the electrical connection system coupled together with a locking plate removed;

FIG. 4 is a perspective view of the electrical connection system with one of the electrical connectors disconnected;

FIG. 5A is a top view of the locking plate;

FIG. 5B is a view of one end the locking plate;

FIG. 5C is a view of another end the locking plate;

FIG. 5D is a view of one side of the locking plate;

FIG. 5E is bottom view of the locking plate;

FIG. 6 is a perspective view of an electrical connection system in accordance with other embodiments of the present invention;

FIG. 7 is mirror images, cross-sectional view of the electrical connection system shown in FIG. 6;

FIG. 8 is a perspective view of the locking plate for the electrical connection system shown in FIG. 6; and

FIG. 9 is a side view of the locking plate shown in FIG. 8.

### DETAILED DESCRIPTION

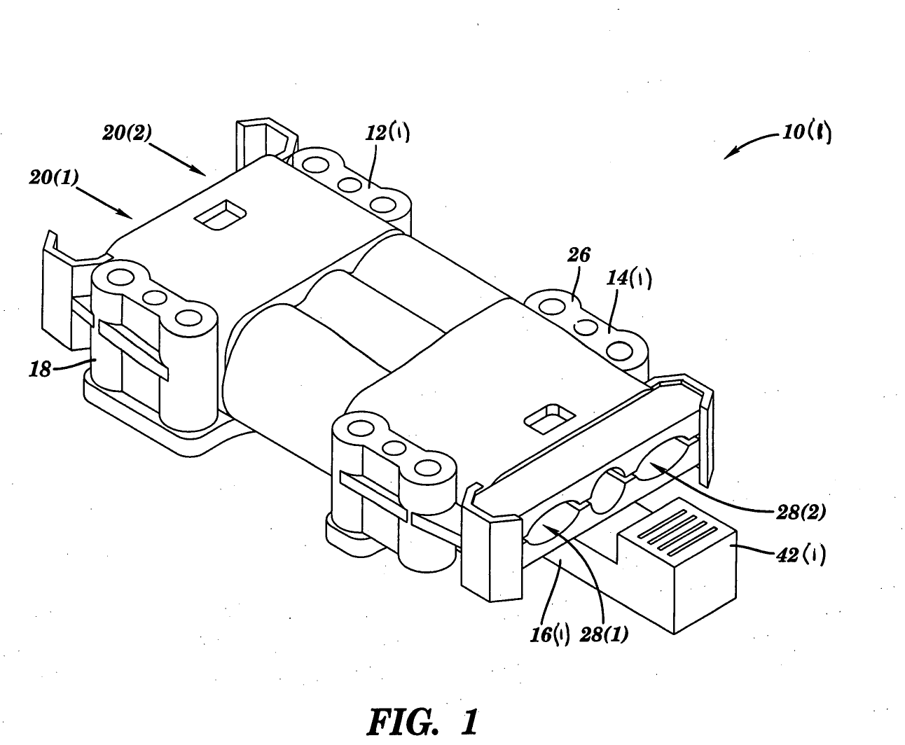

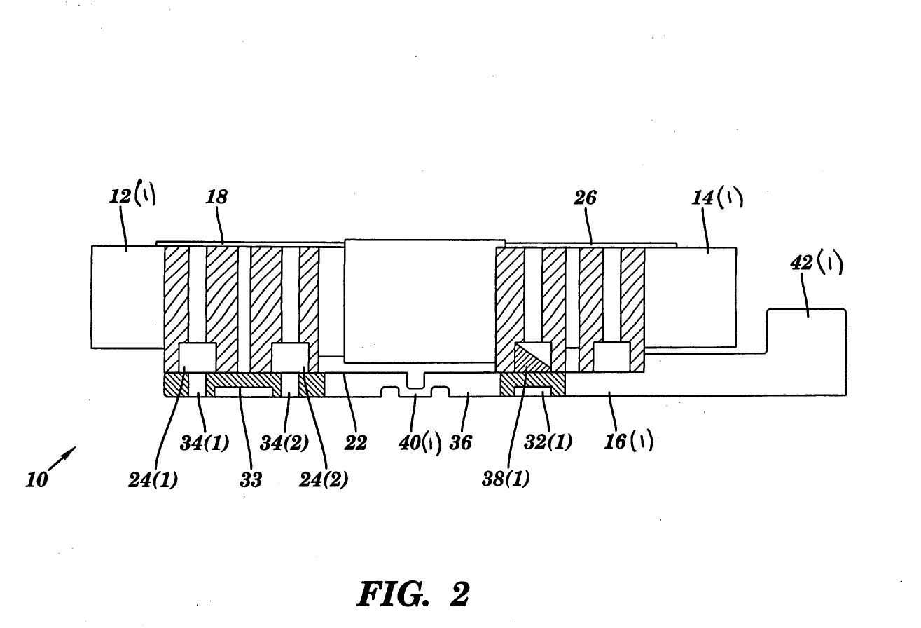

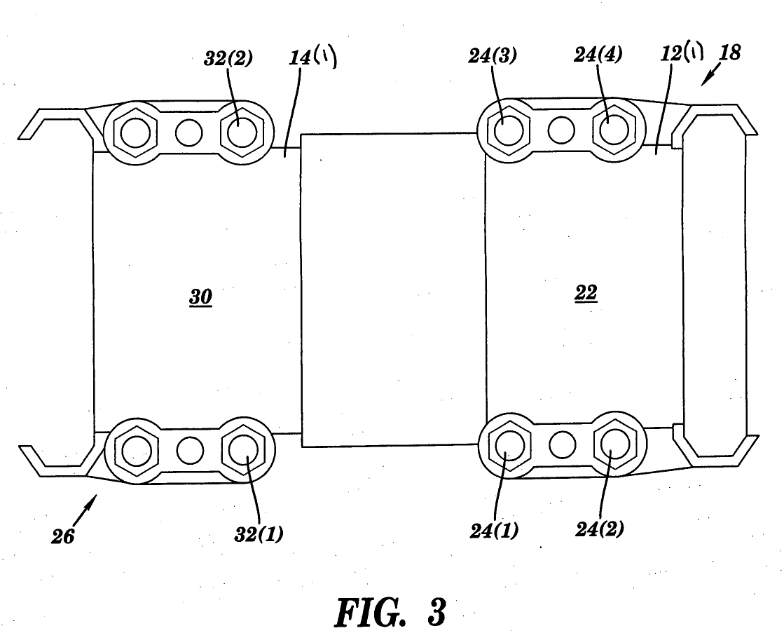

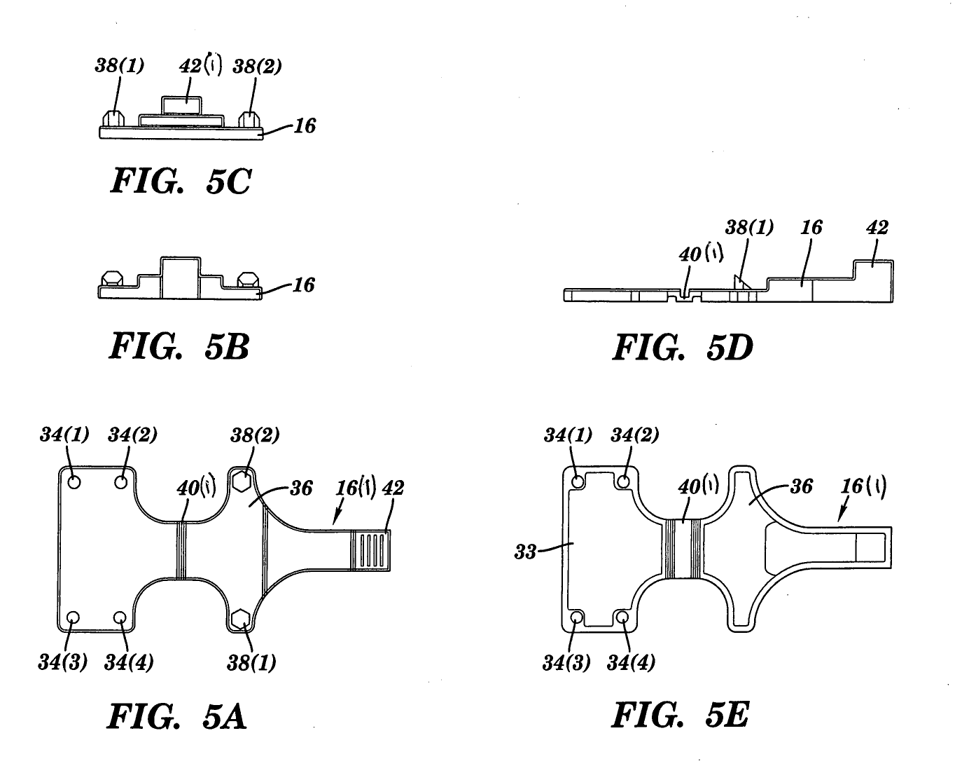

An electrical connection system 10(1) in accordance with an embodiment of the present invention is illustrated in FIGS. 1-5E. The electrical connection system 10(1) includes a first electrical connector 12(1), a second electrical connector 14(1), and a locking plate 16(1), although the electrical connection system 10(1) may comprise other types, numbers, and combinations of components. The present invention provides a number of advantages including providing a complete and integrated locking system for electrical connectors with a quick release system.

Referring to FIGS. 1-3, the first electrical connector 12(1) include a first housing 18 with first passages 20(1) and 20(2) to receive and secure a first pair of electrical leads, although the number and shapes of first passages 20(1) and 20(2) to receive first electrical leads can vary and the first electrical leads can be coupled to the first housing 18 in other manners. Since the manner in which electrical leads are secured and coupled to an electrical connector are well know, it will not be described here. The bottom surface 22 of the first housing 18 includes openings 24(1)-24(4) which are used to connect the first electrical connector 12(1) to the locking plate 16 with bolts, although other number of openings and other types of securing devices can be used to secure the first electrical connector 12(1) to the locking plate 16.

The second electrical connector 14(1) includes a second housing 26 with second passages 28(1) and 28(2) to receive and secure a second pair of electrical leads, although the number and shape of second passages 28(1) and 28(2) to receive second electrical leads can vary and the second electrical leads can be coupled to the second housing 26 in other manners. Since the manner in which electrical leads are secured and coupled to an electrical connector are well know, it will not be described here. The bottom surface 30 of the second housing 26 includes boss openings 32(1) and 32(2) which are used to detachably lock the second electrical connector 14(1) to the first electrical connector 12(1), although the bottom surface 30 of the second electrical connector 14(1) could have other configurations, such as other numbers of opening or one or more bosses or other projections which engage one or more openings on the locking plate 16(1).

The first electrical connector 12(1) is a female connector and the second electrical connector 14(1) is a male electrical connector which can be mated together to form an electrical connection, although other types of first and second electrical connectors 12(1) and 14(1) can be used, such as genderless electrical connectors or other male and female connector configurations. Since the manner in which electrical connectors are coupled together to form an electrical connection and to couple leads coupled to each of the electrical connectors together is well know, it will not be described here.

Referring to FIGS. 1, 2, and 4-5E, the locking plate 16(1) includes a first section 33 with holes 34(1)-34(4), although the first section 33 can have other numbers of holes. The holes 34(1)-34(4) are spaced apart substantially the same distance apart as the openings 24(1)-24(4) on the bottom surface 22 of the first housing 18. When the locking plate 16(1) is positioned to be secured to the bottom surface 22 of the first housing 18, the holes 34(1)-34(4) are substantially aligned with the openings 24(1)-24(4). Bolts extend into the holes 34(1)-34(4) in the first section 33 of the locking plate 16 and the openings 24(1)-24(4) in the first housing 18 to secure the first section 33 of the locking plate 16(1) to the first housing 18, although other types of securing devices can be used to connect to secure the first section 33 of the locking plate 16(1) to the first housing 18.

The locking plate 16(1) includes a second section 36 with a pair of bosses 38(1) and 38(2) projecting from the second section 36 on substantially opposing sides, although the locking plate 16(1) can have other types and numbers of projections in other locations. The bosses 38(1) and 38(2) are spaced apart substantially the same distance apart as the openings 32(1)-32(2) so that when the second electrical connector 14(1) is connected to the first electrical connector 12(1) the bosses 38(1) and 38(2) for the locking plate 16(1) are substantially aligned with the openings 32(1) and 32(2). The detachable engagement of each the bosses 38(1) and 38(2) in one of the boss openings 32(1) and 32(2) detachably locks the second electrical connector 14 to the first electrical connector 12(1). Although the bosses 38(1) and 38(2) are shown on the locking plate 16(1) and the boss openings 32(1) and 32(2) are on the second electrical connector 14(1), other configurations can be used, such as having one or more of the bosses on the second electrical connector 14(1) and one or more of the boss openings on the locking plate 16(1). Additionally, although bosses 38(1) and 38(2) with corresponding boss openings 32(1) and 32(2) are shown as the locking mechanism, other types of detachable locking mechanisms can be used.

The locking plate 16(1) also includes a spring 40(1) which is located between the first section 33 and the second section 36, although other types of biasing or pivoting mechanisms could be used in other locations on the locking plate 16. Since the first section 33 is secured to the first housing 18, with the spring 40(1) the second section 36 can pivot with respect to the first section 33. The spring 40(1) is formed in the locking plate 16 to have a normal or neutral position where the bosses 38(1) and 38(2) on the second section 36 are seated in the boss openings 32(1) and 32(2). The second section 36 can be pivoted about the spring 40(1) to a release position where the bosses 38(1) and 38(2) are withdrawn from the boss openings 32(1) and 32(2) to unlock the second electrical connector 14(1) from the first electrical connector 12(1) and the second section 36 is being biased back to the neutral position by the spring 40. The first and second sections 33 and 36 and the spring 40, could be configured to have other.

A lock release button 42(1) is integrally formed on the second section 36 opposite from the spring 40(1), although other types release mechanisms in other locations could be used. When the lock release button 42(1) is pressed in a general direction away from the second section 36, the second section 36 is moved from the neutral position to the release position about the spring 40(1).

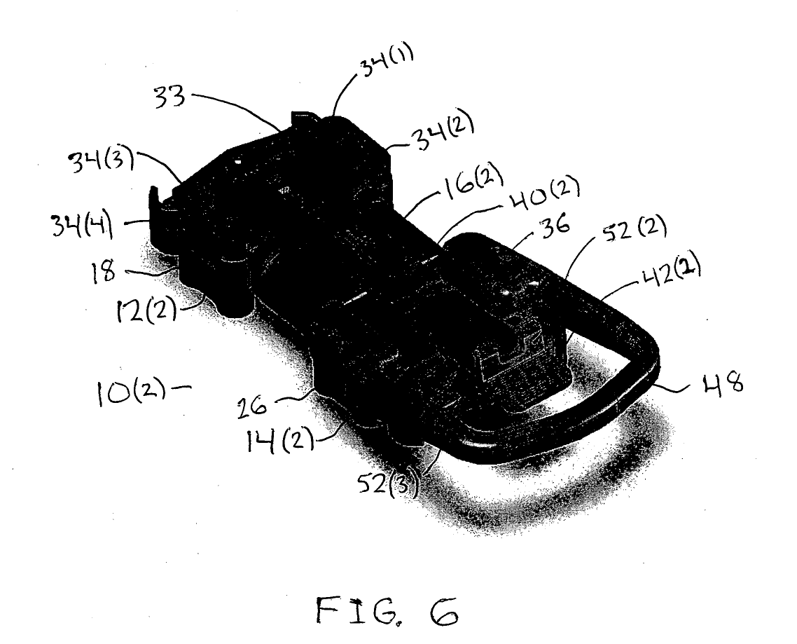

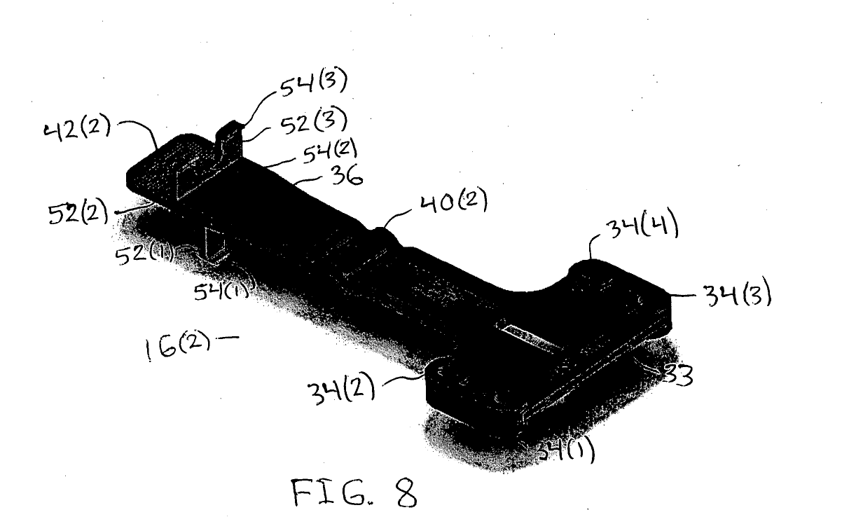

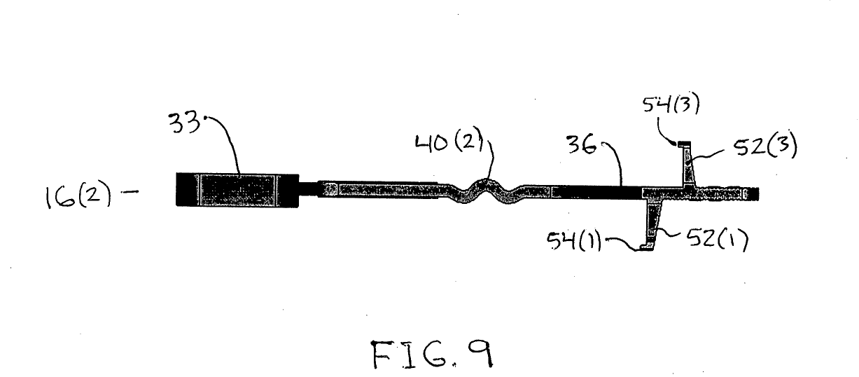

An electrical connection system 10(2) in accordance with other embodiments of the present invention is illustrated in FIGS. 6-9. The electrical connection system 10(2) is the same as the electrical connection system 10(1) except as described and illustrated herein. Elements in electrical connection system 10(2) which are like those in electrical connection system 10(1) will have like reference numerals. The electrical connection system 10(2) includes a first electrical connector 12(2), a second electrical connector 14(2), and a locking plate 16(2), although the electrical connection system 10(2) may comprise other types, numbers, and combinations of components.

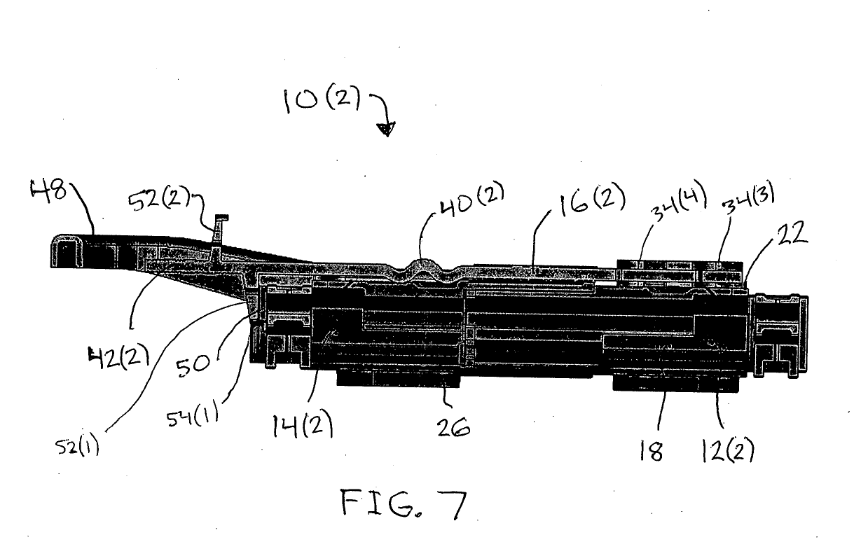

Referring to FIGS. 6-7, the first electrical connector 12(2) include a first housing 18 with first passages to receive and secure a pair of electrical leads like the passages 20(1) and 20(2) shown in the first electrical connector 12(1), although the number and shapes of first passages to receive the first electrical leads can vary and the first electrical leads can be coupled to the first housing 18 in other manners. Since the manner in which electrical leads are secured and coupled to an electrical connector are well know, it will not be described here. The bottom surface 22 of the first housing 18 includes openings, like the openings 24(1)-24(4) shown in the first electrical connector 12(1), which are used to connect the first electrical connector 12(2) to the locking plate 16(2) with bolts, although other number of openings and other types of securing devices can be used to secure the first electrical connector 12(2) to the locking plate 16(2).

The second electrical connector 14(2) includes a second housing 26 with second passages, like the passages 28(1) and 28(2) shown in the first electrical connector 14(1), to receive and secure a second pair of electrical leads, although the number and shape of second passages to receive second electrical leads can vary and the second electrical leads can be coupled to the second housing 26 in other manners. Since the manner in which electrical leads are secured and coupled to an electrical connector are well know, it will not be described here.

The housing 26 of the second electrical connector 14(2) also has a handle 48 which can be used to maneuver the second electrical connector 14(2) to be connected to or disconnected from the first electrical connector 12(2). The handle 48 does not interfere with the locking system. The handle 48 has a U-shape, although other types, numbers and shapes of handles can be used.

The second housing 26 in electrical connector 14(2) also has a protrusion 50 which acts like a catch of a latch and is used to mate with one or more of the fasteners 52(1)-52(3) of locking plate 16(2) to lock the first electrical connector 12(2) to the second electrical connector 14(2), although other manners for locking the first and second electrical connectors 12(2) and 14(2) together can be used. The protrusion 50 extends away from a face of the second housing 26 and has a rectangular shape, although the other numbers, types and shapes of protrusions and also other types of catches for protrusion 50 could be used. For example, multiple protrusions 50 or other catches could be used. Additionally, the protrusion 50 may have a groove or other indentation along a surface in which a portion of the lip 54(1) of fastener 52(1) could be seated in when engaged with the protrusion 50. The fastener 52(1) will only be detachably engaged with the protrusion 50 when the first and second electrical connectors 12(2) and 14(2) are fully and securely mated together.

The first electrical connector 12(2) is a female connector and the second electrical connector 14(2) is a male electrical connector which can be mated together to form an electrical connection, although other types of first and second electrical connectors 12(2) and 14(2) can be used, such as genderless electrical connectors or other male and female connector configurations. Since the manner in which electrical connectors are coupled together to form an electrical connection and to couple leads coupled to each of the electrical connectors together is well know, it will not be described here.

Referring to FIGS. 6-9, the locking plate 16(2) includes a first section 33 with holes 34(1)-34(4), although the first section 33 can have other numbers of holes. The holes 34(1)-34(4) are spaced apart substantially the same distance apart as the corresponding openings on the bottom surface 22 of the first housing 18 of the first electrical connector 12(2). When the locking plate 16(2) is positioned to be secured to the bottom surface 22 of the first housing 18 of the first electrical connector 12(2), the holes 34(1)-34(4) are substantially aligned with the openings 24(1)-24(4). Bolts extend into the holes 34(1)-34(4) in the first section 33 of the locking plate 16(2) and the corresponding openings in the first housing 18 of the first electrical connector 12(2), although other types of securing devices can be used to connect to secure the first section 33 of the locking plate 16(2) to the first housing 18. The first electrical connector 12(2) can be secured to either side of the first section 33 depending upon which of the fasteners 52(1)-52(3) are desired for the particular application. For example, if a more secure detachable engagement is desired, then the first electrical connector 12(2) may be secured to the side of plate 16(2) with the two fasteners 52(2) and 52(3) or, depending on the combined length of the connected housings 18 and 26 of the first and second electrical connectors 12(2) and 14(2), the first electrical connector 12(2) may be secured to the side of plate 16(2) which has the fastener 52(1) or fasteners 52(2) and 52(3) at the appropriate position along the length of the plate 16(2) to detachably engage the protrusion 50 or other catch.

The locking plate 16(2) also includes a second section 36 with fasteners 52(1)-52(3), although the locking plate 16(2) could have other numbers, types and shapes of fasteners which could extend in other directions and could have other types of securing devices. Fastener 52(1) extends in a substantially perpendicular direction from a face of and adjacent one end of second sections 36 and fasteners 52(2)-52(3) extend in a substantially perpendicular and an opposing direction from fastener 52(1) from another face of second section 36, although other configurations can be used. Each of the fasteners 52(1)-52(3) has a protruding lip 54(1)-54(3), respectively, and each of the fasteners 52(1)-52(3) is flexible with respect to second section 36 of locking plate 16(2), although each of the fasteners 52(1)-52(3) could have other parts and configurations. The fastener 52(1) is spaced in from fasteners 52(2) and 52(3) along the length of the plate 16(2) to enable locking plate 16(2) to be used with mated housings 18 and 26 of the first and second electrical connectors 12(2) and 14(2) which have different combined lengths. Additionally, the use of multiple fasteners, such as the two fasteners 52(2) and 52(3), on one side of the plate 16(2) provide a more secure detachable lock.

The locking plate 16(2) also includes a spring 40(2) which is located between the first section 33 and the second section 36, although other types of biasing or pivoting mechanisms could be used in other locations on the locking plate 16(2). The spring 40(2) has a sinusoidal cross sectional shape, although the spring 40(2) could have other shapes. Since the first section 33 is secured to the first housing 18, with the spring 40(2) the second section 36 can pivot with respect to the first section 33. The spring 40(2) is formed in the locking plate 16 to have a normal or neutral position where the lip 54(1) of fastener 52(1) or the lips 54(2) and 54(3) of fasteners 52(2) and 52(3) are engaged with the protrusion 50. The second section 36 can be pivoted in opposing directions about the spring 40(2) away from the housing 26 of the second electrical connector 14(2) to a release position where the lip 54(1) of fastener 52(1) or the lips 54(2) and 54(3) of fasteners 52(2) and 52(3) are released from protrusion 50 to unlock the second electrical connector 14(2) from the first electrical connector 12(2). In this release position, the second section 36 of the plate 16(2) is being biased back to the neutral position by the spring 40(2).

A lock release button 42(2) is integrally formed on and on opposing sides of the second section 36 opposite from the spring 40(2), although other types release mechanisms in other locations could be used. The lock release button 42(2) is an extension of the second section 36 of locking plate 16(2) with ribbing along an outer surface of the lock release button 42(2), although the lock release button 42(2) could have other shapes and configurations. When the lock release button 42(2) is pressed in a general direction away from the second electrical connector 14(2), the second section 36 is moved from the neutral position to the release position about the spring 40(2).

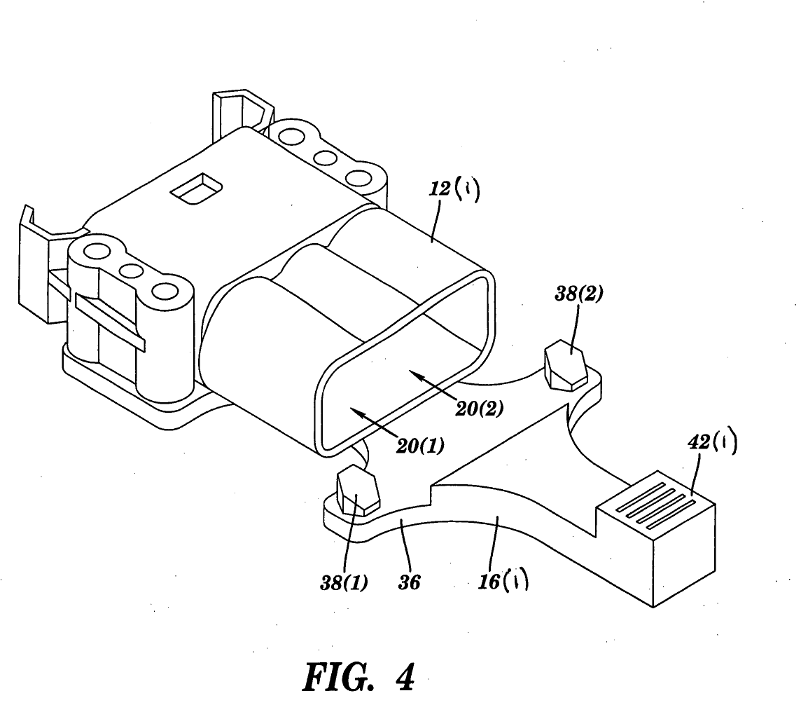

The operation of the electrical connection system 10(1) will be described with reference to FIGS. 1-5E. The first section 33 of locking plate 16(1) is secured to the first electrical connector 12(1) with bolts through the openings 24(1)-24(4) and 34(1)-34(4), although other manners for securing the first section 33 of locking plate 16(1) to the first electrical connector 12(1) can be used. The second section 36 of the locking plate 16(1) extends out past the female mating end of the first electrical connector 12(1) as shown in FIG. 4.

Next, the male housing 26 of the second electrical connector 14(1) is mated with the female housing 18 of the first electrical connector 12(1) to electrically couple the first and second electrical connectors 12(1) and 14(1) together. This also couples the electrical leads in passages 20(1) and 20(2) to the electrical leads in passages 28(1) and 28(2) together.

To permit the first and second housings 18 and 26 of the first and second electrical connectors 12(1) and 14(1) to mate, the lock release button 42(1) is pushed away from the general desired location of the second electrical connector 14(1). When the release button 42(1) is pushed, the second section 36 is moved from the neutral position to the release position.

Once the first and second electrical connectors 12(1) and 14(1) are coupled together, the release button 42(1) is release and the spring 40(1) biases the second section 36 back to the neutral position. When the second section 36 returns to the neutral position, the bosses 38(1) and 38(2) mate with the boss openings 32(1) and 32(2) on the surface 30 of the second electrical connector 14(1). The engagement of the bosses 38(1) and 38(2) in the boss openings 32(1) and 32(2) detachably locks the first and second electrical connectors 12(1) and 14(1) together.

To break the connection between the first and second electrical connectors 12(1) and 14(1), the release button 42(1) is pressed in a general direction away from the second section 36. The second section 36 is moved from the neutral position to the release position about the spring 40(1). This movement breaks the engagement of the bosses 38(1) and 38(2) from the boss openings 32(1) and 32(2) unlocks the first and second electrical connectors 12(1) and 14(1). The second electrical connector 14(1) is then disconnected from the first electrical connector 12(1) to break the electrical connection.

The operation of the electrical connection system 10(2) will be described with reference to FIGS. 6-9. Depending on the combined length of the mated housings 18 and 26 of the first and second electrical connectors 12(2) and 14(2), the appropriate side of plate 16(2) is selected and the housing 18 of the first electrical connector 12(2) is secured to the selected side of the section 36 of plate 16(2). By way of example, if the connected housings 18 and 26 of the first and second electrical connectors 12(2) and 14(2) have a shorter combined length then the they are secured to the side of plate 16(2) with fastener 52(1) and if they have a larger combined length then they will be connected to the opposing side of plate 16(2) with fasteners 52(2) and 52(3). Additionally, if a more secure detachable lock is desired, then the housing 18 of the first electrical connector 12(2) is secured to the side of plate 16(2) with multiple fasteners 52(2) and 52(3). Multiple plates 16(2) with different combinations of number and locations of fasteners can be selected from.

The first section 33 of locking plate 16(2) is secured to the first electrical connector 12(2) with bolts through the openings in first electrical connector 12(2) which correspond with openings 34(1)-34(4) in plate 16(2), although other manners for securing the first section 33 of locking plate 16(2) to the first electrical connector 12(2) can be used. The second section 36 of the locking plate 16(2) extends out past the female mating end of the first electrical connector 12(2) as shown in FIGS. 6 and 7.

Next, the male housing 26 of the second electrical connector 14(2) is mated with the female housing 18 of the first electrical connector 12(2) to electrically couple the first and second electrical connectors 12(2) and 14(2) together. The handle 48 can be used to assist with the mating of the first and electrical connectors 12(2) and 14(2). When the first and second electrical connectors 12(2) and 14(2) are mated, the electrical leads in passages 20(1) and 20(2) to the electrical leads in passages 28(1) and 28(2) are coupled together.

To permit the first and second housings 18 and 26 of the first and second electrical connectors 12(2) and 14(2) to mate, the lock release button 42 is pushed away from the general desired location of the second electrical connector 14(2). When the release button 42(2) is pushed, the second section 36 is moved from the neutral position to the release position.

Once the first and second electrical connectors 12(2) and 14(2) are coupled together, the release button 42(2) is released and the spring 40(2) biases the second section 36 back to the neutral position. When the second section 36 returns to the neutral position, the lip 54(1) of fastener 52(1) engages protrusion 50 engages protrusion 50 on second electrical connector 14(2), although other arrangements could be used, such as having the lips 54(2) and 54(3) of fasteners 52(2) and 52(3), respectively, engage the protrusion 50 if the first and second electrical connectors were located on the opposing side of plate 16(2). This engagement detachably locks the first and second electrical connectors 12(2) and 14(2) together.

To break the connection between the first and second electrical connectors 12(2) and 14(2), the release button 42(2) is pressed in a general direction away from the second electrical connector 14(2). The second section 36 is moved from the neutral position to the release position about the spring 40(2). This movement breaks the engagement of the lip 54(1) of fastener 52(1) from the protrusion 50 to unlock the first and second electrical connectors 12(2) and 14(2), although other arrangements could be used, such as breaking the engagement of the lips 54(2) and 54(3) of the fasteners 52(2) and 52(3), respectively, from the protrusion if the first and second electrical connectors were located on the opposing side of plate 16(2). The second electrical connector 14(2) can then be disconnected from the first electrical connector 12(2) by pulling on handle 48 to break the electrical connection.

Accordingly, as described above the present invention provides a complete and integrated locking system for electrical connectors which prevent the electrical connectors from coming apart during use. Additionally, the present invention provides a mechanism which is simple and easy for an operator to use to quickly unlock electrical connectors.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefor, is not intended to limit the claimed processes to any order except as may be specified in the claims. Accordingly, the invention is limited only by the following claims and equivalents thereto.

What is claimed is:

1. An electrical connection system, the system comprising:
a first electrical connector with a first housing;
a second electrical connector with a second housing, the second housing having one of a catch and a fastener along one surface;
a plate connected to the first housing, the plate having the other one of the catch and the fastener, when the first housing is connected to the second housing to couple the first electrical connector to the second electrical connector the fastener is detachably engaged with the catch to detachably lock the first electrical connector to the second electrical connector.

2. The system as set forth in claim 1 wherein the second electrical connector and the plate have at least two or more of the fasteners to lock the second electrical connector to the first electrical connector.

3. The system as set forth in claim 1 wherein the second electrical connector and the plate have at least two or more of the fasteners and two or more of the catches with at least one of the fasteners and one of the catches on opposing sides of the plate.

4. The system as set forth in claim 3 wherein the at least one of the fasteners and the one of the catches on opposing sides of the plate are offset from each other along a length of the plate.

5. The system as set forth in claim 1 wherein the plate has a neutral position where the fastener is detachably engaged to the catch and a release position where the fastener is disengaged from the catch to unlock the second electrical connector from the first electrical connector.

6. The system as set forth in claim 1 wherein the plate comprises:
a first section connected to the first electrical connector;
a second section having the other one of the catch and the fastener; and
a biasing element connected between the first and second sections, the biasing element is spaced a first distance away from the other one of the catch and the fastener on the plate.

7. The system as set forth in claim 6 wherein the second section has a neutral position where the fastener is detachably engaged to the catch and a release position where the fastener is disengaged from the catch to unlock the second electrical connector from the first electrical connector.

8. The system as set forth in claim 1 wherein the first electrical connector is one of a male electrical connector and a female electrical connector and the second electrical connector is the other one of the male electrical connector and the female electrical connector.

9. A method of making an electrical connection system, the method comprising:
providing a first electrical connector with a first housing;
providing a second electrical connector with a second housing, the second housing having one of a catch and a fastener along one surface;
connecting a plate to the first housing, the plate having the other one of the catch and the fastener; and
detachably engaging the fastener to the catch to detachably lock the first electrical connector to the second electrical connector when the first housing is connected to the second housing.

10. The method as set forth in claim 9 wherein the second electrical connector and the plate have at least two or more of the fasteners to lock the second electrical connector to the first electrical connector.

11. The method as set forth in claim 9 wherein the second electrical connector and the plate have at least two or more of the fasteners and two or more of the catches with at least one of the fasteners and one of the catches on opposing sides of the plate.

12. The method as set forth in claim 11 wherein the at least one of the fasteners and the one of the catches on opposing sides of the plate are offset from each other along a length of the plate.

13. The method as set forth in claim 9 wherein the plate has a neutral position where the fastener is detachably engaged to the catch and a release position where the fastener is disengaged from the catch to unlock the second electrical connector from the first electrical connector.

14. The method as set forth in claim 9 wherein the plate comprises:
a first section connected to the first electrical connector;
a second section having the other one of the catch and the fastener; and
a biasing element connected between the first and second sections, the biasing element is spaced a first distance away from the other one of the catch and the fastener on the plate.

15. The method as set forth in claim 14 wherein the second section has a neutral position where the fastener is detachably engaged to the catch and a release position where the fastener is disengaged from the catch to unlock the second electrical connector from the first electrical connector.

16. The method as set forth in claim 9 wherein the first electrical connector is one of a male electrical connector and a female electrical connector and the second electrical connector is the other one of the male electrical connector and the female electrical connector.

17. A method for securing electrical connectors, the method comprising:
coupling a first electrical connector which is connected to a plate to a second electrical connector; and
detachable engaging at least one of a fastener and a catch on the second connector with the other one of the fastener and the catch on the plate to detachably lock the first electrical connector to the second electrical connector.

18. The method as set forth in claim 17 wherein the detachable engaging further comprises detachably engaging at least two or more of the fasteners on one of the second electrical connector and the plate to the catch on the other one of the second electrical connector and the plate to lock the second electrical connector to the first electrical connector.

19. The method as set forth in claim 17 further comprising:
selecting a side of the plate to connect to the second electrical connector, wherein the plate has at least one of two or more of the fasteners and two or more of the catches on opposing sides of the plate; and
connecting the selected side of the plate to the first electrical connector.

20. The method as set forth in claim 19 wherein the at least one of two or more of the fasteners and two or more of the catches on opposing sides of the plate are offset from each other along a length of the plate.

21. The method as set forth in claim 17 further comprising pivoting the plate from a neutral position where the fastener is detachably engaged to the catch to a release position where the fastener is disengaged from the catch to unlock the second electrical connector from the first electrical connector.

22. The method as set forth in claim 17 wherein the plate comprises:
a first section connected to the first electrical connector;
a second section having the other one of the projection and the projection opening; and
a biasing element connected between the first and second sections, the biasing element is spaced a first distance away from and is not adjacent to the other one of the fastener and the catch.

23. The method as set forth in claim 22 further comprising pivoting the second section from a neutral position where the fastener is detachably engaged to the catch to a release position where the fastener is disengaged from the catch to unlock the second electrical connector from the first electrical connector.

24. The method as set forth in claim 17 wherein the first electrical connector is one of a male electrical connector and a female electrical connector and the second electrical connector is the other one of the male electrical connector and the female electrical connector.
